(19) United States
(12) Patent Application Publication
(10) Pub. No.: US 2016/0121795 A1
(43) Pub. Date: May 5, 2016

(54) SIDE MIRROR SYSTEM FOR AUTOMOTIVE VEHICLES

(71) Applicant: Makoto Smith, Torrance, CA (US)

(72) Inventor: Makoto Smith, Torrance, CA (US)

(21) Appl. No.: 14/529,073

(22) Filed: Oct. 30, 2014

(51) Int. Cl. B60R 1/02

(52) U.S. Cl. CPC B60R 1/025

(57) ABSTRACT

A side mirror system for a vehicle is provided, including right and left mirror units, each including multiple mirrors, which are configured to be adjustable for viewing vicinities of the vehicle during driving forward and during driving in reverse. One or more of the multiple mirrors are configured to be adjustable for viewing a blind spot. The system further includes a mirror control module coupled to the right and left mirror units and used for adjusting mirror orientations and storing one or more settings of the mirror orientations customized for the one or more users, respectively. The setting for each of the one or more users includes a first subset for driving forward and a second subset for driving in reverse, and the mirror control module controls the mirror orientations according to the second subset for driving in reverse upon detecting that the gear is in reverse.

### BACKGROUND

Automotive vehicles are conventionally equipped with two side view mirrors and one rear view mirror. The angles of these mirrors are manually or electrically adjusted by a driver so that the optimal orientations can be assumed for the driver to have rear and peripheral views as wide as possible. However, it is known that the views provided by these mirrors do not cover 100% of the areas that should be carefully observed by the driver during operation. In general, a driver cannot see an object in a blind spot with the conventionally installed mirrors, and thus he/she has to turn his/her head and upper body to observe with own eyes the area in the blind spot during changing lanes, for example. Failure to do so often causes a collision with another vehicle in the blind spot. Driving in reverse, for backing up to a garage or for parallel parking, is another maneuver that requires very careful observation of the vicinities, in particular, right behind the vehicle. However, lack of visibility often causes an accident such as colliding with an object or, in the most tragic case, running over a small child unnoticed by the driver.

In view of the limited visibility, as normally provided by using the conventionally installed mirrors on a vehicle, various prior art mechanisms have been proposed for detecting an object in the proximity of a vehicle followed by issuance of a warning to the driver, automatic activation of the brake, automatic turn to avoid the object, etc. However, no drastic improvements to the mirror systems have been implemented to date for increasing the range of visibility, including blind spots and rear areas, for the driver to better observe the vicinities of the vehicle.

### BRIEF DESCRIPTION OF THE DRAWINGS

FIG. 1 illustrates a front view of an example of a mirror unit, according to an embodiment, mounted on the left with respect to a driver sitting at a driver's seat in a vehicle.

FIG. 2 is a block diagram illustrating an example of a side mirror system according to an embodiment.

FIG. 3 is a block diagram illustrating an example the mirror control module, including the program unit, the mirror adjustment unit and the memory unit, as those illustrated in FIG. 2.

FIG. 4 is an example of a lookup table illustrating the way the data is stored in the memory unit.

FIG. 5 illustrates a top view of an example of the setting of the mirror orientations of the left mirror unit for driving forward including blind spot detection.

FIGS. 6A and 6B illustrate a top view and a side view, respectively, of an example of the setting of the mirror orientations of the left mirror unit for driving in reverse.

FIG. 7 is an example of a lookup table illustrating the way the data is stored in the memory unit, wherein one or more mirrors of each mirror unit used for blind spot detection assume default orientations for normal viewing when blind spot detection is not necessary.

FIG. 8 illustrates a top view of an example of the setting of the mirror orientations of the left mirror unit for driving forward, for normal viewing with M1 N, M2 and M3, and for blind spot detection with M1 BS, M2 and M3.

### DETAILED DESCRIPTION

In view of the problems and safety concerns associated with the limited visibility normally provided by conventionally installed mirrors on a vehicle, this document provides a new side mirror system configured to provide wide viewing ranges that can be customized for each possible driver of the vehicle. Examples of implementations according to the present embodiments are described below with reference to accompanying drawings.

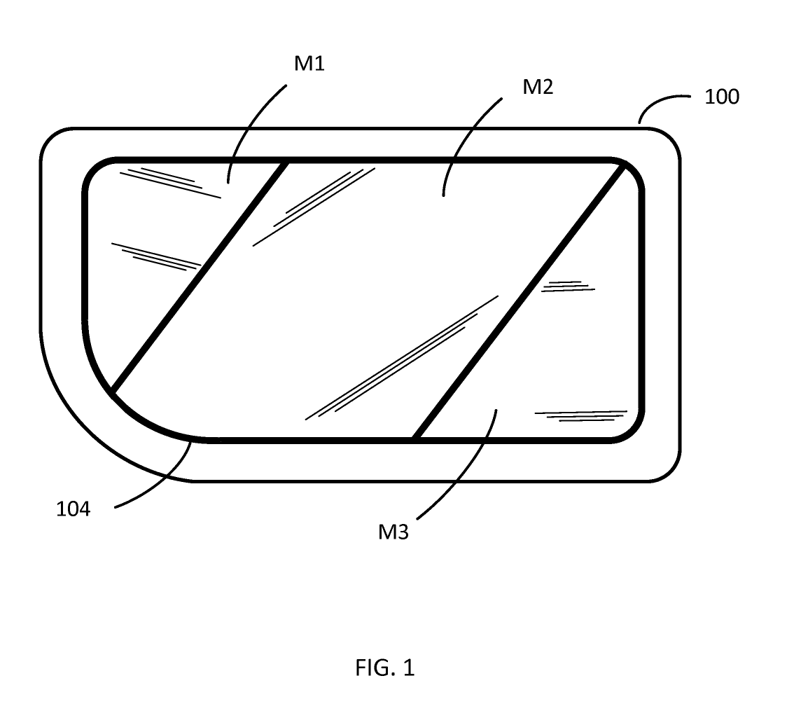

FIG. 1 illustrates a front view of an example of a mirror unit 100, according to an embodiment, mounted on the left side with respect to a driver sitting at a driver's seat in a vehicle. Typically, only one mirror is implemented in a view section 104 in most vehicles. This example includes three mirrors, M1, M2 and M3, which are included in the mirror unit 100 to substantially cover the surface area of the view section 104 designed for the driver to see the reflected images of things behind and to the sides of the vehicle. The number of mirrors is not limited to three; the mirror unit 100 according to the embodiment may comprise two or more mirrors, and the size and dimensions of each mirror may be predetermined according to ergonomics and other needs for driving safety, ease and convenience. The mirror unit 100 is accommodated in a housing, which is connected to a side door, a front fender or other suitable part of the vehicle, forming a part of the body of the vehicle. It should be understood that there is a second mirror unit on the right side, and the front view of the right mirror unit is substantially symmetric to the left mirror unit 100 illustrated in FIG. 1.

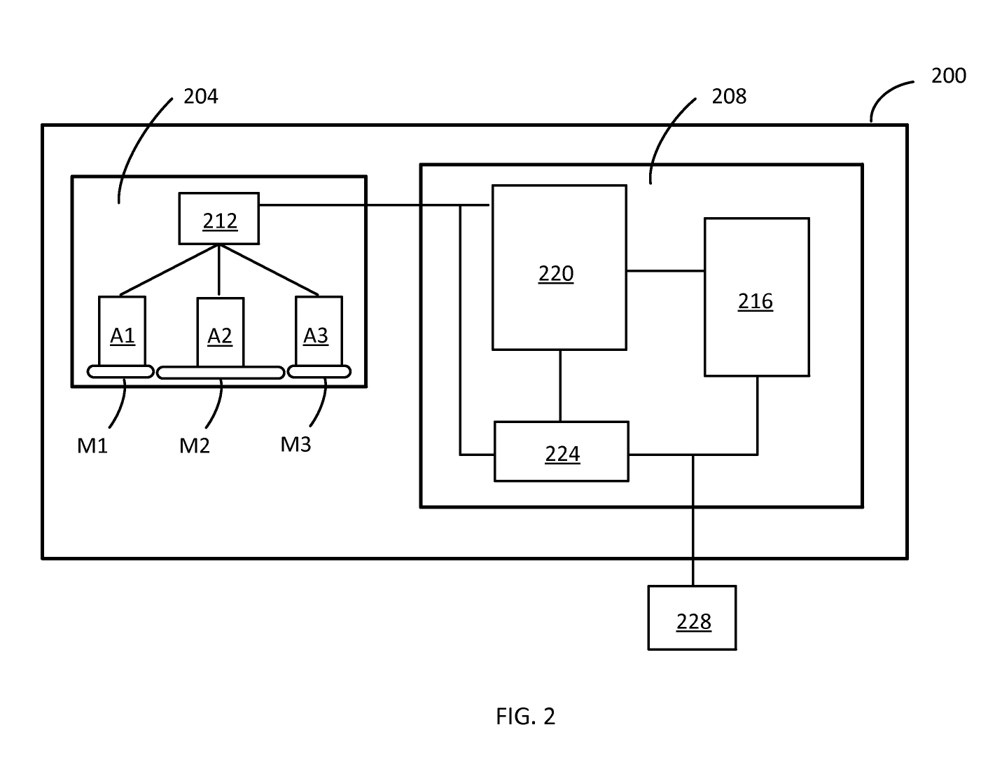

FIG. 2 is a block diagram illustrating an example of a side mirror system 200 according to an embodiment. The side mirror system 200 includes a mirror unit 204, the front view of an example of which is illustrated in FIG. 1. The mirror unit 204 may represent a mirror unit on the left side of the vehicle, and is coupled to a mirror control module 208. Although not shown in FIG. 2, it should be understood that there is a second mirror unit mounted on the right side of the vehicle and coupled to the mirror control module 208, wherein the second mirror unit is configured to be substantially identical in functionality and substantially symmetric in structure to the left mirror unit 204, such as illustrated in FIG. 1. The side mirror system 200 includes the mirror control module 208 coupled to the right and left mirror units. The mirror unit 204 in FIG. 2 is represented by a schematic top view thereof, including three mirrors M1, M2 and M3, three angle actuating units A1, A2 and A3 coupled to the mirrors M1, M2 and M3, respectively, and a motor drive unit 212 coupled to the angle actuating units A1, A2 and A3. The example of FIG. 2 includes three mirrors M1, M2 and M3 and three corresponding angle actuating units A1, A2 and A3, respectively. However, as mentioned earlier, two or more mirrors, hence two or more angle actuating units coupled to the mirrors, respectively, can be included in the mirror unit 204. The size and dimensions of each mirror may be predetermined according to ergonomics and other needs for driving safety, ease and convenience. The motor drive unit 212 may include a controller, at least one motor, drives, shafts, pins, connectors and other electronic and mechanical parts, where the controller may be configured to receive signals from the mirror control module 208 and to control the motor movement accordingly. Each of the angle actuating units A1, A2 and A3 is configured to adjust the angle of the mirror coupled thereto by converting the motor movement to movements for orienting the mirror according to the signals transmitted from the mirror control module 208. Alternatively to having at least one motor in the motor drive unit 212, the angle actuating units A1, A2 and A3 may include motors to move respective mirrors M1, M2 and M3, as controlled by the controller in the motor drive unit 212. The motor can be an electric solenoid motor or any other motor as known by one skilled in the art. The mechanical and electrical components, circuits and configurations, as well as the way of converting the motor movement to movements for adjusting the angles of the mirrors via actuators, shafts, pins, connectors, etc. can be designed and implemented by one skilled in the art. A gap between each pair of adjacent mirrors can also be predetermined by one skilled in the art, so that the mirrors do not interfere with each other or generate friction with each other during the movement of one mirror while the angle is being adjusted.

The mirror control module 208 includes a program unit 216, a mirror adjustment unit 220 and a memory unit 224. The program unit 216 is configured to receive inputs or commands from each of one or more users to initiate adjusting the angles and store one or more sets of the mirror orientations that have been adjusted and determined to be suitable for the one or more users, respectively. The mirror adjustment unit 220 is coupled to the program unit 216. Upon receiving the input or command to start adjusting the angles of the mirrors from the program unit 216, the mirror adjustment unit 220 is used to further receive inputs from the user for adjusting the angles of the mirrors. The mirror adjustment unit 220 outputs signals to the motor drive unit 212 of the mirror unit 204 for changing the angle of each mirror according to the inputs while the user is trying to find the most suitable orientation of the mirror. When the set of the mirror orientations suitable for one user is determined, he/she can issue a command on the program unit 216 to set the orientations and store the setting of the orientations in the memory unit 224. The memory unit 224 may be coupled to the mirror adjustment unit 220, the program unit 216 and the mirror unit 204. Once one or more sets of the mirror orientations suitable for the one or more users, respectively, are stored in the memory unit 224, each of the one or more users can select his/her own setting by using the program unit 216, before starting driving. The output signals corresponding to the selected setting are sent from the program unit 216, to the memory unit 224 to look up and choose the selected setting, and to the motor drive unit 212 of the mirror unit 204 to drive the one or more motors for adjusting the mirror orientations according to the selected setting.

The controlling signals from the mirror control module 208 can be electrical through a wire, or wireless based on the RF-wave, microwave or other suitable wireless communication means. The mirror control module 208 may be implemented on the left side door, on the front panel or with the steering wheel, as long as it is accessible to the driver sitting at the driver's seat. The program unit 216, the mirror adjustment unit 220 and the memory unit 220 in the mirror control module 208 may be separately implemented, or at least part of them may be integrated.

The mirror control module 208 includes various programs for adjusting and storing the orientations of the mirrors as well as looking up the stored data. The program unit 216 and the mirror adjustment unit 220 include a user interface, which is a set of commands or menus through which a user communicates with the programs. A menu-driven interface may be used so that a user can input desired information by selecting command choices from various menus displayed on the touchscreen or mechanically arranged on the board based on switch, dial and/or knob mechanisms. The mirror control module 208 may be further coupled to one or more systems 228 of the vehicle for selecting at least portion of the stored data according to the condition of the one or more systems 228.

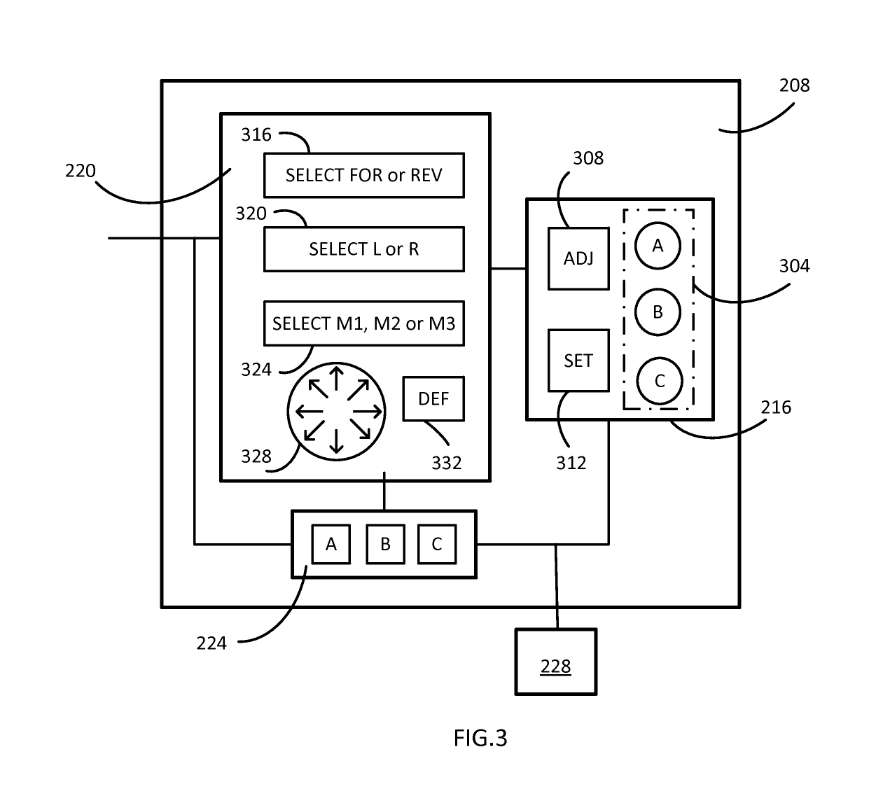

FIG. 3 is a block diagram illustrating an example of the mirror control module 208 including the program unit 216, the mirror adjustment unit 220 and the memory unit 224, as those illustrated in FIG. 2. This block diagram schematically depicts the associated user interface. The program unit 216 includes a driver selection section 304, an adjustment start section 308, and a set section 312. The driver selection section 304 includes three buttons A, B and C corresponding to three different drivers A, B and C, respectively, in this example. The number of buttons can be one or more for use as identifiers of one or more drivers, respectively. Instead of three mechanical buttons, the choices can be displayed or scrolled on the touchscreen. To set the orientations of the mirrors suitable for the driver A, the user or the driver A himself/herself sits at the driver's seat and selects the identifier A by pressing the button A or by touching the corresponding portion of the touchscreen. Hereinafter in this document, it should be understood that the user interface can be configured so that a user can input desired information by selecting command choices from various menus displayed on the touchscreen or mechanically arranged on the board based on switch, dial and/or knob mechanisms, as known to one skilled in the art. Thus, “pressing” and “touching” by the user herein shall be interpreted as a same action for selecting and activating the function corresponding to the pressed or touched portion of the user interface. Once the identifier is selected in the driver selection section 304, the user can press the adjustment start section 308 to start adjusting the angles of the mirrors.

The mirror adjustment unit 220 in this example includes various selection menus for the user to adjust the orientations of the mirrors. A first selection section 316 allows the user to select the view during driving forward or in reverse. For driving the vehicle forward, one or more of the mirrors of each of the right and left mirror units 204 can be adjusted to reflect the area in a blind spot. Typically, the outmost mirror M1 of the mirror unit 204 may be used for blind spot detection. Alternatively, the user may decide to disregard blind spot viewing and adjust the mirrors for only normal viewing during driving forward. For reversing the vehicle, the mirrors of each of the right and left mirror units 204 can be adjusted to reflect the areas behind and to the sides of the vehicle clearly for safety and ease during backing up, such as parallel parking. A second selection section 320 allows the user to select the left side mirror unit or the right side mirror unit. A third selection section 324 allows the user to select one of the mirrors of each mirror unit 204. In this example, there are three mirrors M1, M2 and M3 in each mirror unit 204, an example of which is illustrated in FIG. 1. As mentioned earlier, the number of mirrors in each mirror unit 204, hence the number of choices in the third selection section 324, can be two or more. A fourth section 328 allows the user to select the orientation of the selected mirror. As known to one skilled in the art, a knob, a dial or a touchscreen can be used for the user to select the direction and the amount of tilting of the selected mirror to determine the orientation, hence the angle of each mirror. Possible directions can be four, i.e., right, left, up and down, or more such as 6 or 8. When the orientations of all the mirrors are determined, the user can press the set section 312 to store the setting in the memory unit 224 with the identifier of the user, i.e., A, B or C, in this example.

The mirror adjustment unit 220 may further include a fifth section 332, which allows the user to select a default setting, such as a factory setting, for all the mirrors. In an example process, the driver A selects his/her identifier A in the driver selection section 304, then presses the adjustment start section 308, then presses the fifth section 332 to select the default setting, and then presses the set section 312. The mirror orientations per the default setting are stored in the memory unit 224 with the identifier A.

A user, i.e., any one of one or more drivers of the vehicle, can set and store the orientations of the mirrors on the right and left, for driving forward including or disregarding blind spot detection and driving in reverse, by using the present side mirror system 200. Once the setting is stored in the memory unit 224, the user can select his/her own setting by selecting his/her identifier in the driver selection section 304 before driving, or leave it as it is if the same driver drives the vehicle. The mirrors are oriented per the setting as selected in the driver selection section 304, according to the data stored with the identifier in the memory unit 224.

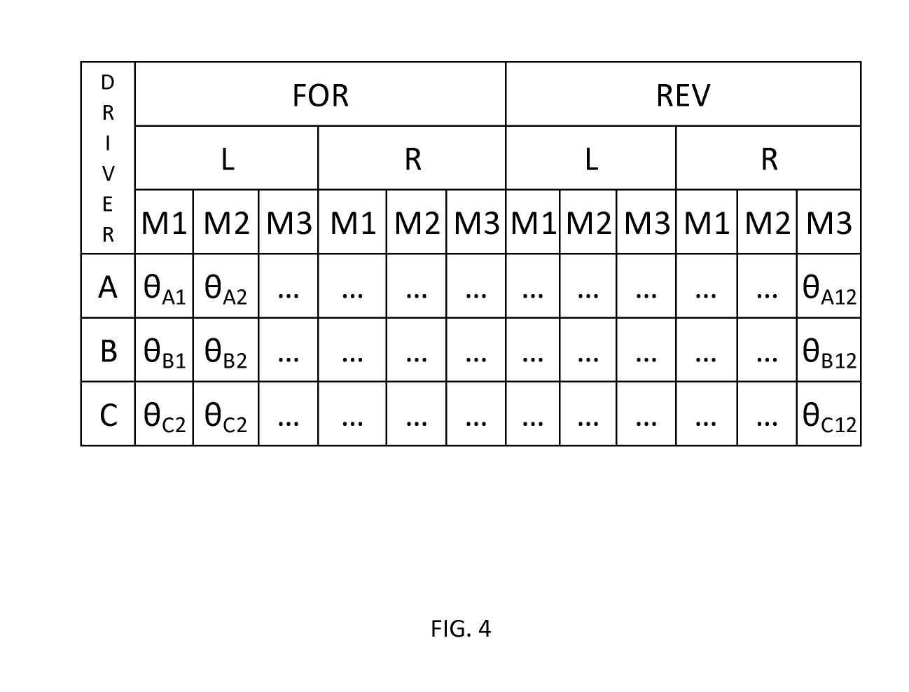

FIG. 4 is an example of a lookup table illustrating the way the data is stored in the memory unit 224. This example illustrates a case of having three different drivers A, B and C, and three different mirrors M1, M2 and M3 in each of the right and left mirror units 204. The value θ represents an orientation of each mirror in terms of the direction, i.e., right, left, up and down, or more in between, and the tilting degree toward that direction. The setting for one driver comprises a set of θ values for M1, M2 and M3 of each of the right and left mirror units, and for driving forward and for driving in reverse. For example, the setting for the driver A has 12 orientations, θ_{A1}, θ_{A2} . . . and θ_{A12}, for 3 mirrors×2 mirror units (right and left)×2 driving directions (forward and reverse) in this example. One or more of the θ values of each of the right and left mirror units for each driver for driving forward may represent the mirror orientations for detecting the blind spot.

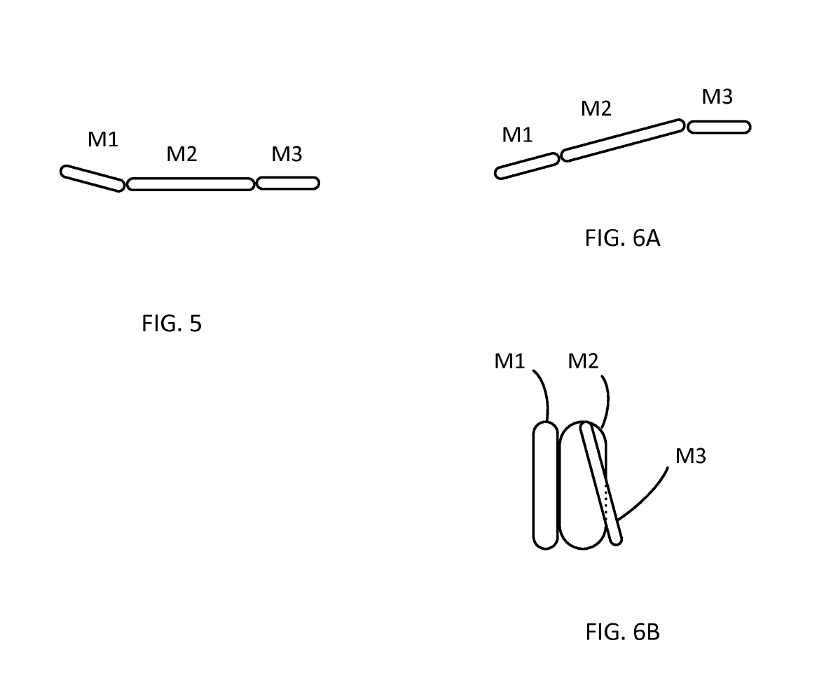

FIG. 5 illustrates a top view of an example of the setting of the mirror orientations of the left mirror unit 204 for driving forward including blind spot detection. In this example, the leftmost mirror M1 is oriented outwardly for detecting a blind spot. Two or more mirrors can be mounted in each of the right and left mirror units 204, and one or more mirrors of each mirror unit 204 can be adjusted for blind spot detection as needed by the driver, while the other mirrors can be adjusted for normal viewing during driving forward. In the case where the user decides to disregard blind spot viewing, the mirrors are adjusted for only normal viewing during driving forward. For example, the mirror M1 may be aligned with the other mirrors M2 and M3 in this case.

FIGS. 6A and 6B illustrate a top view and a side view, respectively, of an example of the setting of the mirror orientations of the left mirror unit 204 for driving in reverse. In this example, the leftmost mirror M1 and the center mirror M2 are oriented inwardly for viewing behind the vehicle as much as possible; and the right most mirror M3 is tilted downwardly to see areas near the ground behind and to the left side of the vehicle. Two or more mirrors can be mounted in each of the right and left mirror units 204, and one or more mirrors of each mirror unit 204 can be adjusted for viewing areas deeply behind the vehicle and/or for viewing areas near the ground for backing up, such as parallel parking, as needed by the driver, while the other mirrors can be adjusted for normal viewing during driving in reverse.

Referring back to the example illustrated in FIGS. 2 and 3, the mirror control module 208 of the side mirror system 200 can be configured to couple to the one or more systems 228 of the vehicle. The one or more systems 228 may include a gear system, either automatic or manual. The mirror control module 208 may be further configured to detect that the gear is in reverse, or the gear system may be configured to send signals to the mirror control module 208 when the gear is in reverse. Upon detecting that the gear is in reverse during driving, the program unit 216 is configured to look up the memory unit 224 and send the information on the mirror orientations for driving in reverse to the mirror unit 204 to adjust the mirrors for driving in reverse. Namely, as soon as the gear is in reverse, the orientations of the mirrors are automatically switched from the orientations for driving forward, such as illustrated in FIG. 5, to the orientations for driving in reverse, such as illustrated in FIGS. 6A and 6B. A software program may be implemented in the mirror control module 208 to toggle the setting from the orientations for driving forward to the orientations for driving in reverse upon detecting that the gear is in reverse.

As explained above, this document describes a side mirror system 200 for a vehicle, including right and left mirror units 204, each including multiple mirrors, which are configured to be adjustable for viewing vicinities of the vehicle during driving forward and during driving in reverse. One or more of the multiple mirrors are configured to be adjustable for viewing a blind spot. In this system 200, a mirror control module 208 is coupled to the right and left mirror units 204 and configured to receive inputs or commands from one or more users for adjusting mirror orientations and for storing one or more settings of the mirror orientations that are determined to be suitable for the one or more users, respectively. The mirror orientations for each user are thus customized and stored in the memory unit 224 with the identifier of each user. The mirror control module 208 is further configured to receive an input or a command from each of the one or more users to select his/her setting from the stored one or more settings and to control the multiple mirrors to have the mirror orientations according to the selected setting. The setting for each of the one or more users includes a first subset for driving forward and a second subset for driving in reverse. The mirror control module 208 is coupled to a gear system of the vehicle and configured to control the multiple mirrors to have the mirror orientations for driving in reverse according to the second subset upon detecting that the gear is in reverse.

The side mirror system 200 in the above example is configured for the case of setting the orientations of mirrors for driving forward including or disregarding blind spot detection, and the setting for driving forward is set as indicated under “FOR” in the lookup table of FIG. 4, during driving except the time when the gear is in reverse. Accordingly, the mirrors are fixed at their respective orientations during forward driving as illustrated in FIG. 5, except the time when the gear is in reverse. In addition, the side mirror system 200 according to another embodiment may be configured so that the mirror orientations for blind spot detection are activated on limited occasions.

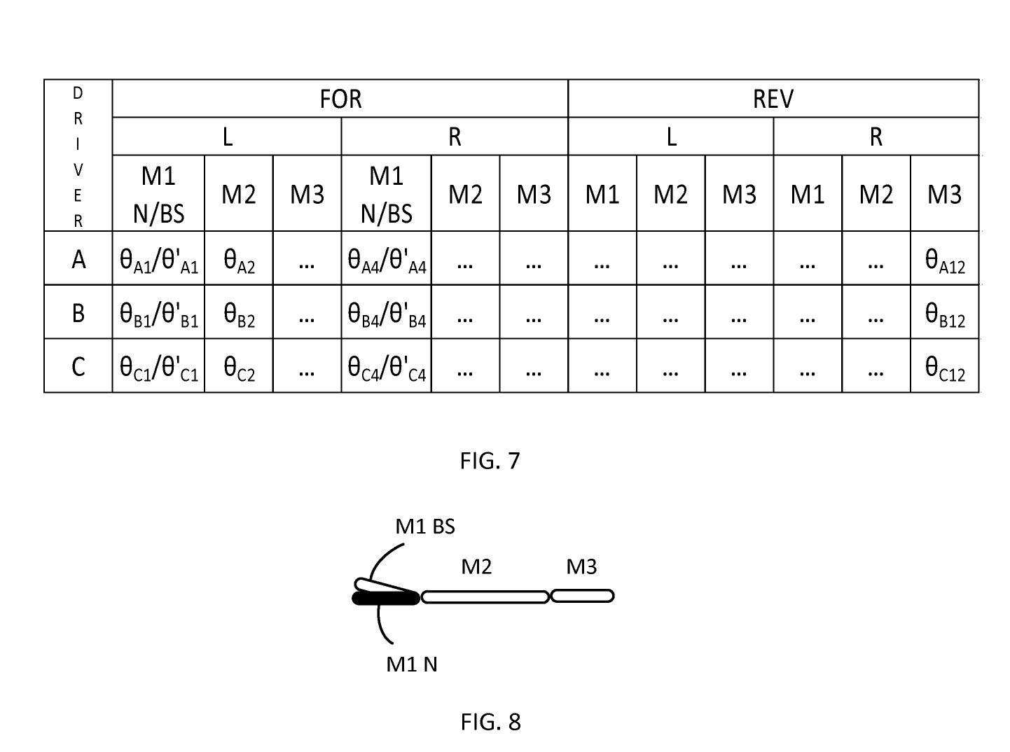

FIG. 7 is an example of a lookup table illustrating the way the data is stored in the memory unit 224, wherein one or more mirrors of each mirror unit 204 used for blind spot detection assume orientations for normal viewing when blind spot detection is not necessary. The lookup table of FIG. 7 illustrates a case of having three different drivers A, B and C, and three different mirrors M1, M2 and M3 in each of the right and left mirror units 204. The value θ represents an orientation of each mirror in terms of the direction, i.e., right, left, up and down, or more in between, and the tilting degree toward that direction. The setting for one driver comprises a set of θ values for M1, M2 and M3 of each of the right and left mirror units 204, and for driving forward and for driving in reverse. In this example, the mirror M1 is used for blind spot detection. The orientation of M1 for normal viewing and the orientation of M1 for blind spot detection are stored under “M1 N/BS.” For example, the setting for the driver A includes θ_{A1} for normal viewing and θ′_{A4} for blind spot detection for the mirror M1 on the left, and θ_{A4} for normal viewing and θ′_{A4} for blind spot detection for the mirror M1 on the right.

FIG. 8 illustrates a top view of an example of the setting of the mirror orientations of the left mirror unit 204 for driving forward, for normal viewing with M1 N, M2 and M3, and for blind spot detection with M1 BS, M2 and M3.

Specifically, referring back again to FIG. 3, the one or more systems 228 may further include a turn signal system in addition to the gear system. The mirror control module 208 may be further configured to detect that the left or right turn signal is on, or the turn signal system may be configured to send signals to the mirror control module 208 when the left or right turn signal is on. Upon detecting that the left or right turn signal is on during driving, the program unit 216 is configured to look up the memory unit 224 and send the information on the mirror orientations for detecting blind spots to the mirror unit 204 to adjust the mirrors for driving forward including blind spot detection. Namely, as soon as the left or right turn signal is on, the orientations of the mirrors are automatically switched from the orientations for normal forward driving, such as illustrated with M1 N in FIG. 8, to the orientations for driving forward including blind spot detection, such as illustrated with M1 BS in FIG. 8.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed is:

1. A side mirror system for a vehicle, comprising:
right and left mirror units, each comprising a plurality of mirrors, which are configured to be adjustable for viewing vicinities of the vehicle during driving forward and during driving in reverse, wherein one or more of the plurality of mirrors are configured to be adjustable for viewing a blind spot; and
a mirror control module coupled to the right and left mirror units and configured to receive inputs or commands from one or more users for adjusting mirror orientations of the plurality of mirrors of each of the right and left mirror units and for storing one or more settings of the mirror orientations customized for the one or more users, respectively, and further configured to receive an input or a command from each of the one or more users to select his/her setting from the stored one or more settings and to control the plurality of mirrors of each of the right and left mirror units to have the mirror orientations according to the selected setting,
wherein
the setting for each of the one or more users includes a first subset for driving forward and a second subset for driving in reverse, and
the mirror control module is coupled to a gear system of the vehicle and configured to control the plurality of mirrors of each of the right and left mirror units to have the mirror orientations for driving in reverse according to the second subset upon detecting that the gear is in reverse.

2. The side mirror system of claim 1, wherein
the first subset includes a third subset that has the mirror orientations of the one or more of the plurality of mirrors of each of the right and left mirror units for viewing the blind spot.

3. The side mirror system of claim 2, wherein
the first subset further includes a fourth subset that has the mirror orientations of the one or more of the plurality of mirrors of each of the right and left mirror units for driving forward without viewing the blind spot.

4. The side mirror system of claim 3, wherein
the mirror control module is further coupled to a turn signal system of the vehicle, and configured to control the mirror orientation of the one or more of the plurality of mirrors of each of the right and left mirror units according to the third subset for viewing the blind spot upon detecting that a turn signal is on.

5. The side mirror system of claim 1, wherein
each of the right and left mirror units includes one or more motors coupled to the plurality of mirrors to adjust the mirror orientations according to signals from the mirror control module.

6. The side mirror system of claim 1, wherein
a mirror control module comprises:
a mirror adjustment unit for adjusting the mirror orientations of the plurality of mirrors of each of the right and left mirror units by receiving inputs or commands from the one or more users;
a memory unit for storing the one or more settings of the mirror orientations customized for the one or more users, respectively; and
a program unit for selecting the setting for each of the one or more users from the one or more settings stored in the memory unit to control the plurality of mirrors of each of the right and left mirror units to have the mirror orientations according to the selected setting.
